(19) United States
(12) Patent Application Publication
(10) Pub. No.: US 2015/0056336 A1
(43) Pub. Date: Feb. 26, 2015

(54) SYSTEM AND METHOD FOR MANUFACTURE OF PIZZA PRODUCTS

(71) Applicant: Elwha LLC, Bellevue, WA (US)

(72) Inventors: SAMUEL J. FAHEY-BURKE, SEATTLE, WA (US); NATHAN P. MYHRVOLD, MEDINA, WA (US); HUAN LARISSA ZHOU, SEATTLE, WA (US); ALISTAIR K. CHAN, BAINBRIDGE ISLAND, WA (US)

(73) Assignee: Elwha LLC, a limited liability company of the State of Delaware

(21) Appl. No.: 13/974,283

(22) Filed: Aug. 23, 2013

(51) Int. Cl. A21C 11/00; A21D 13/00

(52) U.S. Cl. CPC A21C 11/004; A21D 13/007
USPC 426/94; 99/353; 426/502; 425/112

(57) ABSTRACT

An improved system and method for the manufacture of pizza products is disclosed. A set of cavities is formed in the shell in a cavity-forming operation. The cavity-forming operation may be performed in a fixture using a set of ports or outlets to inject a fluid to form the cavities and/or to fill the cavities with a fill material. A tool may be used to form the shell and/or the set of cavities (which may be filled or empty or in a combination). The fill material may be cheese or tomato/vegetable segment or pizza sauce or the like. The cavities may be formed in the edge or crust of the pizza product or in the center region of the pizza product. The pizza product may be commercially distributed as a frozen pizza product, including as a finished pizza product with toppings or as a pizza shell.

### FIELD

The present invention relates to a system and method for the manufacture of pizza products. The present invention also relates to pizza products that can be manufactured with the system and method.

### CROSS-REFERENCE TO RELATED APPLICATIONS

Priority Applications: [None]

Related Applications: (a) U.S. patent application Ser. No. 13/974,256, entitled SYSTEM AND METHOD FOR PRODUCING BREAD PRODUCTS, naming N. Myhrvold, L. Zhou and S. Fahey-Burke as inventors, filed Aug. 23, 2013, with Docket no. 0712-038-001-000000, is related to and incorporated by reference in the present application; and (b) U.S. patent application Ser. No. 13/974,270, entitled SYSTEM AND METHOD FOR PRODUCING BREAD PRODUCTS, naming N. Myhrvold, H. Zhou and S. Fahey-Burke as inventors, filed Aug. 23, 2013, with Docket no. 0712-038-002-000000, is related to and incorporated by reference in the present application.

### BACKGROUND

It is well known to provide a pizza product having a shell formed from a dough component that provides the base or substrate for toppings such as pizza sauce, cheese, meat segments, vegetables segments, fruit segments, etc. that is cooked (baked) into a pizza. To form a shell of a pizza the dough component is typically mixed and then flattened to a sheet and formed into the desired shape, individually (e.g. as a single disc or form) or in volume (e.g. with a plurality of discs or forms cut into shape from the sheet); the toppings are then added onto the interior region of the shell. A pizza product is may be finished for consumption by cooking (e.g. baking in a conventional oven or cooking in a microwave oven). The production of a finished pizza product for consumption by commonly known processes is relatively simple and straightforward, able to be completed by individual persons at home kitchens, in restaurants, in commercial/institutional facilities, etc.

The commercial/volume manufacture of pizza products for commercial distribution (e.g. transport, storage and sale) is also well-known. One known type of pizza product in commercial manufacture is a frozen pizza product with shell and applied toppings combined into a ready-to-cook form and then frozen; the frozen pizza product may be finished for commercial distribution by freezing/packaging and transport to an outlet for storage/stocking and then finished for consumption (e.g. cooked or baked) into a ready-to-eat pizza product at or near the time of consumption. Another known type of pizza product in commercial manufacture is a refrigerated pizza product with shell and applied toppings combined into a ready-to-cook form and refrigerated; the refrigerated pizza product is later finished (e.g. cooked or baked) into a ready-to-eat pizza product at or near the time of consumption. It is also of course well-known to provide a ready-to-eat pizza product as a commercial product (e.g. sold in whole or in slices/parts at a pizza restaurant or other restaurant, concession, cafeteria, etc.).

When a pizza product is finished for consumption (e.g. cooked or baked), the dough component of the shell is formed into a baked shell and the toppings are heated and/or melted (e.g. typically into a more integrated form) on the top of the interior region of the shell. During finishing, the exposed perimeter edge of the dough component of the shell may form what is called the “crust” of the pizza product. Notwithstanding that the entire shell is made from the same dough component, it is common that after the pizza product is finished (cooked or baked), the portion of the shell forming the crust will have a texture somewhat different than the portion of the shell that is beneath the toppings. The “crust” effect may be notable on the underside of the pizza shell as well as at the perimeter of the pizza product.

In the selection of pizza products, persons may not only exhibit a preference for particular toppings and combinations of toppings, but also for particular forms of shell or crust in the pizza product. For example, it is known in the manufacture of pizza product to provide for variations in the form of the shell of the pizza, for example, to provide a thin shell to produce a “thin crust” pizza product or a thicker shell to produce a “thick crust” pizza product. Pizza products are sold in many different variations of toppings and forms of shell. In some known variations, such as a “pan pizza” the shell of the pizza may be particularly thick and “doughy” (moist); in other known variations the shell of the pizza may be particularly thin and “crispy” (dry); in other known variations the shell of the pizza may have some intermediate form (e.g. “hand-tossed”). In any event, a conventional type of pizza product finished for consumption may have a shell that exhibits a different consistency and texture at the edge region or exposed “crust” (e.g. dry and has a relatively firm/crisp surface) than beneath the toppings in the interior region (e.g. relatively moist and pliable). It is not uncommon for the type of shell and crust of a pizza product to be identified as a product feature or selling point by a vendor or outlet and evaluated as a consideration in preference and selection by a customer who intends to purchase or consume a pizza product.

It is not uncommon that at the time a pizza product is consumed, certain persons may choose not to consume the exposed edge crust of the pizza product (though some persons may enjoy the entire pizza product including the crust and others may enjoy the crust itself). Perhaps due to the differences in consistency/texture of the crust and absence of toppings in comparison to the portion of the pizza product that is more commonly eaten in full, it is not uncommon at or after the time a pizza product is served for consumption, that portions of the crust of the pizza product are the readily-identifiable portion of any residual uneaten portions of the pizza product (perhaps along with certain portions of a topping or toppings). In may be considered by some persons as wasteful and inefficient that when a pizza product is served for consumption there remain residual uneaten portions of an otherwise edible foodstuff.

It is known to provide for pizza product that has a “filled” crust, as one apparent effort to encourage consumption of the crust of the pizza product (i.e. to promote the more complete consumption of the pizza product and less waste). In known pizza products, the fill material for a filled crust may comprise pizza sauce or cheese (e.g. similar or identical to the pizza sauce or cheeses used in the toppings). One known method of producing the effect of a filled crust is to fold the outer edges of the dough component of the shell over and around the intended fill material forming an enclosed pocket of the crust to contain the fill material. It is also known to form the crust of the pizza with an exposed recess or receptacle that may contain the fill material.

There is identified an opportunity for improved systems and methods of commercial manufacture of a pizza product and for improved configurations of pizza products suitable for high-volume cost-efficient production of pizza products that are tasteful and appealing to purchasers/consumers (e.g. more likely to be consumed in full, in all portions including the crust).

### SUMMARY

The present invention relates to an apparatus to produce a pizza product having a shell formed from a dough component. The apparatus comprises a base, a fixture within the base for supporting the dough component formed into the shell, and a tool configured with a set of ports inserted into the dough component of the shell to form a set of cavities in the shell by a cavity-forming operation. The shell comprises an interior region and a perimeter region outside of the interior region.

The present invention also relates to a process for producing a pizza product comprising the steps of: mixing a first set of ingredients into a dough component, forming the first dough component into a shell, forming a set of cavities in the shell with a cavity-forming operation, and finishing the pizza product.

The present invention further relates to a system for producing a pizza product. The system comprises a mixing station for mixing a first set of ingredients into a dough component, a shape-forming station comprising an apparatus for forming the dough component into a generally flat pizza shell having a perimeter region and an interior region and a thickness, a cavity-forming station comprising an apparatus with a set of outlets for forming a set of cavities in the shell in a cavity-forming operation, and a finishing station for finishing the pizza shell into the finished pizza product.

The present invention further relates to a pizza product. The product comprises a shell formed from a dough component. The shell has an interior region and a perimeter region outside of the interior region. A set of cavities is formed within the dough component of the shell adjacent an edge of the perimeter region of the shell by a cavity-forming operation. Toppings may be applied to the interior region of the shell. The perimeter edge of the shell around the toppings is configured to form a crust when the pizza product is baked. The finished pizza product from the shell comprises a set of cavities in the crust.

The present invention further relates to a pizza product. The product comprises a shell formed from a dough component. The shell has an interior region with a set of generally depressed areas and generally raised ridges within a perimeter region providing a raised edge around the interior region relative to the depressed areas. A set of cavities is formed within the raised ridges and raised edge of the shell by a cavity-forming operation. The raised ridges and raised edge of the shell with the depressed areas in the interior of the shell define locations for toppings to be applied. The raised ridges and raised edge of the shell when baked provide a crust-like effect so that the finished pizza product will comprise a set of identifiable individual segments of a filled-crust pizza product.

The present invention further relates a pizza product as a shell formed from a dough component. The shell has an interior region and a perimeter region outside of the interior region. A set of cavities is formed within the shell in the interior region of the shell by a cavity-forming operation. The set of cavities is filled with a fill material so that the pizza product has a filled shell.

The summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic top view of a pizza according to an exemplary embodiment.

FIGS. 2A-2C are schematic fragmentary views of a crust of a shell for a pizza according to an exemplary embodiment.

FIGS. 3A-3C are schematic perspective views of a shell for a pizza according to an exemplary embodiment.

FIG. 3D is a schematic perspective view of a shell for a pizza according to an exemplary embodiment.

FIGS. 4A-4C are schematic diagrams of a system for producing a shell of a pizza according to an exemplary embodiment.

FIG. 5 is a schematic side view of a fixture for the system according to an exemplary embodiment.

FIGS. 6A-6B are schematic top views step* for the system according to an exemplary embodiment.

FIGS. 6C-6G are schematic top perspective views of fixtures for the system according to an exemplary embodiment.

FIGS. 7A-7F are schematic cut-away side views of a fixture for the system in operation according to an exemplary embodiment.

FIGS. 8A-8J are schematic cut-away side views of a fixture for the system in operation according to an exemplary embodiment.

FIGS. 9A-9J are schematic cut-away side views of a fixture for the system in operation according to an exemplary embodiment.

FIGS. 10A-10D are schematic cut-away side views of a fixture for the system in operation according to an exemplary embodiment.

FIGS. 11A-11D are schematic cut-away diagrams of the crust of the shell of a pizza according to an exemplary embodiment.

FIGS. 12A-12F are schematic cross-section diagrams of a fixture for a system according to an exemplary embodiment.

FIGS. 12G-12H are schematic partial cross-section views of the fixture of FIGS. 12A-12F.

FIG. 12I is a schematic cross-section diagram of a fixture for a system according to an alternative embodiment.

FIGS. 13A-13E are schematic cross-section diagrams of a fixture for a system in operation according to an exemplary embodiment.

FIGS. 14A-14E are schematic cross-section diagrams of a fixture for a system in operation according to an exemplary embodiment.

FIG. 15A is a schematic perspective view of a shell for a pizza according to an alternative embodiment.

FIG. 15B is a schematic top view of the shell of FIG. 15A.

FIG. 15C is a schematic cross-section diagram of a fixture for producing a shell of the type shown in FIGS. 15A-15B.

FIG. 16A is a schematic perspective view of a port for the fixture of the system according to an exemplary embodiment.

FIGS. 16B-16G are schematic cut-away views of the operation of a port for the system according to an exemplary embodiment.

FIG. 17A is a schematic perspective view of a port for the fixture of the system according to an exemplary embodiment.

FIGS. 17B-17G are schematic cut-away views of the operation of a port for the system according to an exemplary embodiment.

FIG. 18A is a schematic perspective view of a port for the fixture of the system according to an exemplary embodiment.

FIG. 18B is a schematic cut-away view of the operation of a step for the system according to an exemplary embodiment.

FIG. 18C is a schematic perspective view of the operation of a port for the system according to an exemplary embodiment.

FIG. 18D is a schematic cut-away view of the operation of a port for the system according to an exemplary embodiment.

FIG. 18E is a schematic perspective view of the operation of a port for the system according to an exemplary embodiment.

FIG. 18F is a schematic cut-away view of the operation of a port for the system according to an exemplary embodiment.

FIG. 19A is a schematic perspective view of a port for the fixture of the system according to an exemplary embodiment.

FIGS. 19B-19C are schematic cut-away views of the operation of a port for the system according to an exemplary embodiment.

FIGS. 20A-20B are schematic cut-away side views of a fixture for the system in operation according to an exemplary embodiment.

FIG. 20C is a schematic perspective view of a port for the fixture of the system according to an exemplary embodiment.

FIG. 21A is a schematic system block diagram of the system for producing the pizza/shell product according to an exemplary embodiment.

FIG. 21B is a schematic process flow diagram of the system for producing the pizza/shell product according to an exemplary embodiment.

FIG. 22 is a schematic process flow diagram of the mixing operation of the system according to an exemplary embodiment.

FIG. 23 is a schematic process flow diagram of the mixing operation of the system according to an exemplary embodiment.

FIG. 24 is a schematic process flow diagram of the forming operation of the system according to an exemplary embodiment.

FIGS. 25A-25F are schematic process flow diagrams of the forming operation of the system according to an exemplary embodiment.

FIGS. 26A-26B are schematic process flow diagrams of the finishing operation of the system according to an exemplary embodiment.

FIGS. 27A-27C are schematic process flow diagrams of the finishing operation of the system according to an exemplary embodiment.

FIG. 28 is a schematic process flow diagram of the packing operation of the system according to an exemplary embodiment.

FIG. 29 is a schematic top perspective view of a fixture for the system according to an alternative embodiment.

FIG. 30 is a schematic cross-section diagram of a fixture for the system according to an alternative embodiment.

FIGS. 31A and 31B are schematic top perspective views of a pizza product according to an alternative embodiment.

### DESCRIPTION

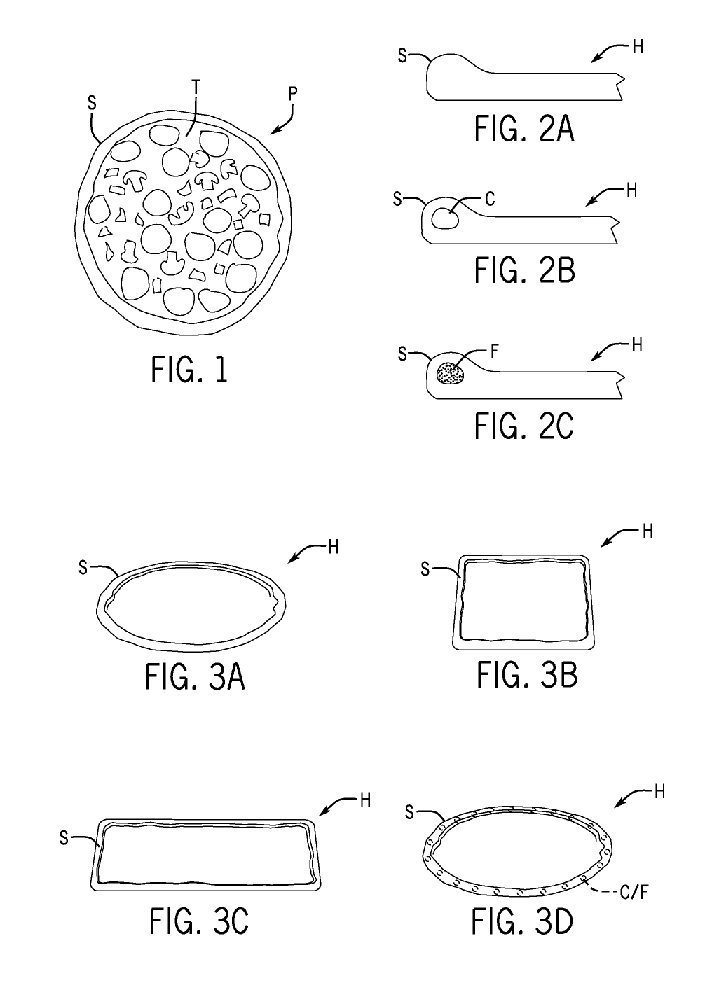

Referring to FIG. 1, a pizza P is shown schematically according to an exemplary embodiment. Pizza P comprises a base or shell H in the form of a flat shape (shown as a disk) made from a dough component (e.g. mixed from ingredients including flour, water, etc.); shell H provides a base or substrate area for toppings T (e.g. tomato sauce, cheese, meat segments, vegetable segments, fruit segments, mushrooms, anchovies, etc.); as indicated, shell H also provides an exposed edge or perimeter segment (not covered by toppings) of the dough component that when the pizza is baked (or otherwise cooked) forms a crust S.

As shown in FIG. 1, according to an exemplary embodiment, the crust S provides a distinct edge or rim around the exterior perimeter of the pizza P (which may be upraised relative to the flat base of the shell H). As indicated schematically in FIGS. 3A-C, the base of the shell S for the pizza is generally flat and can be provided in any of a wide variety of shapes and forms such as circular (FIG. 3A), square (FIG. 3B), rectangular (FIG. 3C), etc.; the edges of the shell (forming what will be the crust of the pizza when baked) will have the general shape and form of the perimeter of the shell according to an exemplary embodiment. Referring to FIGS. 2A-2B, the crust S of the shell H for a pizza is shown according to exemplary embodiments. As indicated in FIG. 2A, the segment of the dough component of the shell that will form the crust of the pizza is given a distinct thicker form (e.g. upraised and thickened relative to the center portion or base/substrate of the shell); as indicated in FIGS. 1 and 2A, the distinct (thicker) form of the segment for crust S provides (among other functions) a visual and physical barrier to the toppings T of the pizza P and allows for the more convenient handling of the pizza or a slice or segment of the pizza (e.g. a place for persons to grasp so as to avoid contact with sauce or of toppings). The edge or crust of the pizza when baked/cooked will typically have a different taste and texture (e.g. crisp or chewy and crunchy) than the other portions of shell (e.g. under the toppings and moist, doughy and thin); some persons when consuming a pizza may chose not to eat or may only partially eat the crust of the pizza.

According to one preferred embodiment, the pizza is made by formation of the shell (with crust segment) from a dough component, addition of the toppings and then cooking (e.g. baking) of the combined shell with toppings into a hot pizza where the dough component is baked (set) into the form of a baked bread product and the toppings are simultaneously heated and cooked/melted (e.g. so that the hot pizza can be sold and/or consumed shortly after preparation either as a whole pizza or by the slice or portion). According to another preferred embodiment, the formed shell of the pizza may be par-baked or set into form prior to application of the toppings; after the toppings are added or applied, the combined shell with toppings (e.g. uncooked pizza) may be maintained for later use (e.g. refrigerated or frozen); a pizza assembled with shell and toppings can subsequently be prepared. According to a common preferred embodiment, the combined shell with toppings is frozen into the common “frozen pizza” product that can be sold at retail outlets such as supermarkets, convenience stores, etc. or to commercial or institutional outlets. The frozen pizza may be purchased and stored (e.g. kept frozen) until later finished by heating (e.g. cooked by microwave oven) or baking (e.g. in a conventional oven, toaster oven, etc.) or otherwise into a hot pizza by or for persons who are prepared to consume the pizza. According to another preferred embodiment, a refrigerated pizza product assembled from shell with toppings (but not baked or frozen) can be sold at retail outlets or to commercial or institutional outlets to be finished by the consumer (e.g. cooked/baked) ultimately at or near the point of sale or consumption (e.g. a concession stand, cafeteria, home kitchen, etc.).

According to another exemplary embodiment, the formed pizza shell can be finished (e.g. par-baked or set) and packaged into a product (e.g. a “pizza shell” product) that is sold to commercial or institutional outlets (e.g. for bulk use) and/or to retail outlets. The pizza shell product can be provided with toppings at or near the point of end use and cooked/baked into a pizza for sale and/or consumption (e.g. at a restaurant, cafeteria, home, etc.).

Referring to FIGS. 2A-2C, configurations of the crust of the shell of a pizza are shown schematically according to exemplary embodiments; the crust S of the pizza shell H can be uniform with no intentional variation of the dough component between the crust and the shell (FIG. 2A); the crust S of the pizza shell H may be provided with at least one internal open (e.g. air-filled) space shown as cavity C (FIG. 2B); the crust S of the pizza shell H be provided with at least one internal cavity including a separate component shown as fill material F (FIG. 2C). According to exemplary embodiments, the component for the fill material may be any of a wide variety of materials, for example, cheese, tomato/pizza sauce, a separate dough component, a mix of materials, (processed) topping materials, or various combinations of materials. As indicated schematically in FIG. 3D, the pockets C/F (e.g. cavities and/or fill segments) may be provided in a set spaced around the perimeter of the edge or crust of the pizza shell (e.g. so that when the pizza of shell and toppings is cooked/baked, melted, etc. or an open cavity (if any) defined and established). As indicated, the fill material in a cavity may be concealed or only partially visible or exposed within the crust of the shell of the pizza.

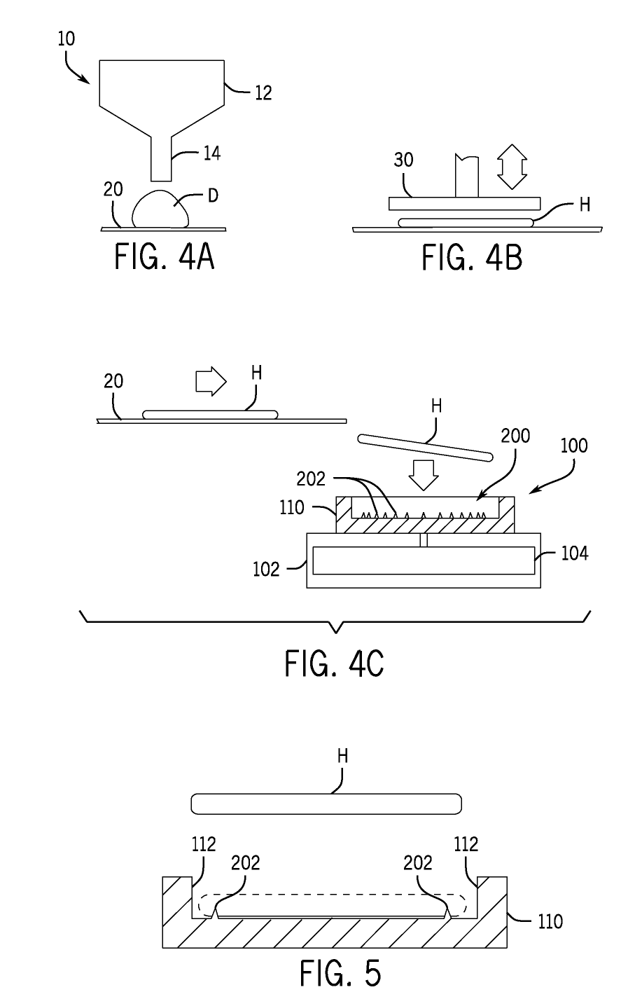

Referring to FIGS. 4A-4C, a system and apparatus for making a pizza shell of the type shown in FIGS. 2B-2C is shown schematically according to an exemplary embodiment. The ingredients for the dough component of the pizza shell are mixed and worked into form to be dispensed by a dispensing station 10 comprising a vessel or vat 12 and an outlet 14 by which the dough component can be dispensed onto a conveying system shown as comprising a belt 20 as a dough ball D. As indicated in FIG. 4B, a forming tool shown as a reciprocating plate 30 works (e.g. forms, flattens and/or cuts) the dough ball into a generally flat shell H. According to an exemplary embodiment, the shell is conveyed to a filling station 100. As indicated, station 100 comprises a fixture 110 into which the shell H will be positioned; station 100 comprises an apparatus/system 200 for forming a set of cavities or at least one cavity (see cavity C in FIG. 2B and cavities C/F in FIG. 3D) or a set of cavities or at least one fill (see fill component F in FIG. 2C and cavities C/F in FIG. 3D) at the edge of the shell. The system comprises a compartment 102 with a plenum 104 (e.g. chamber or manifold) that supplies gas (e.g. air) and/or fill material through a system of outlets or ports 202.

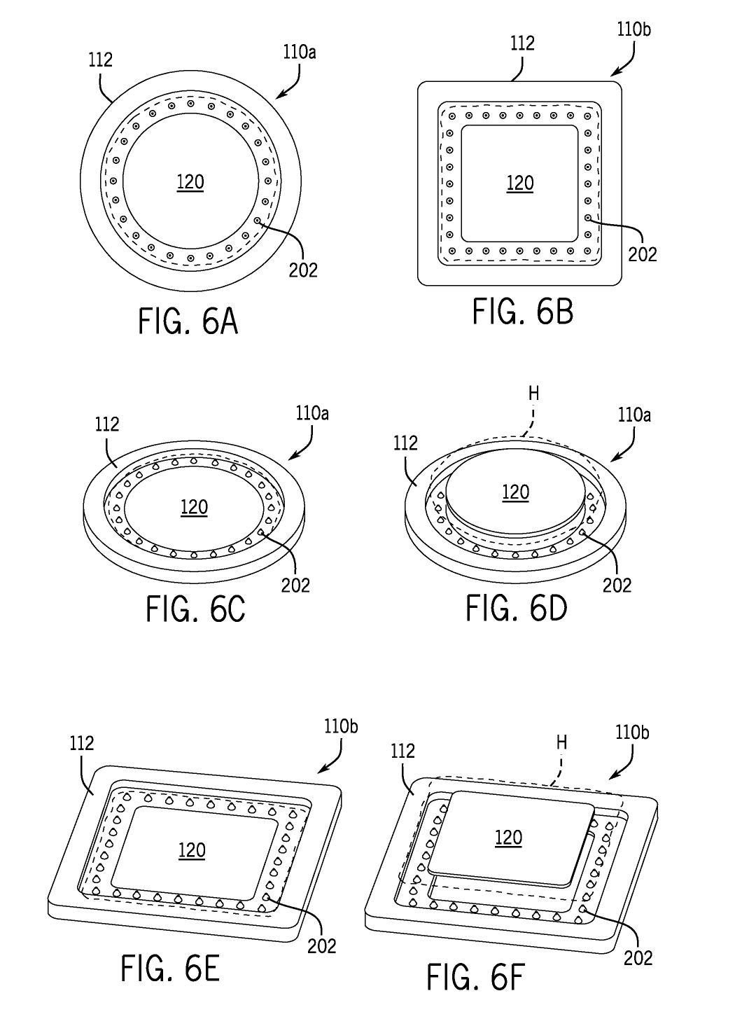

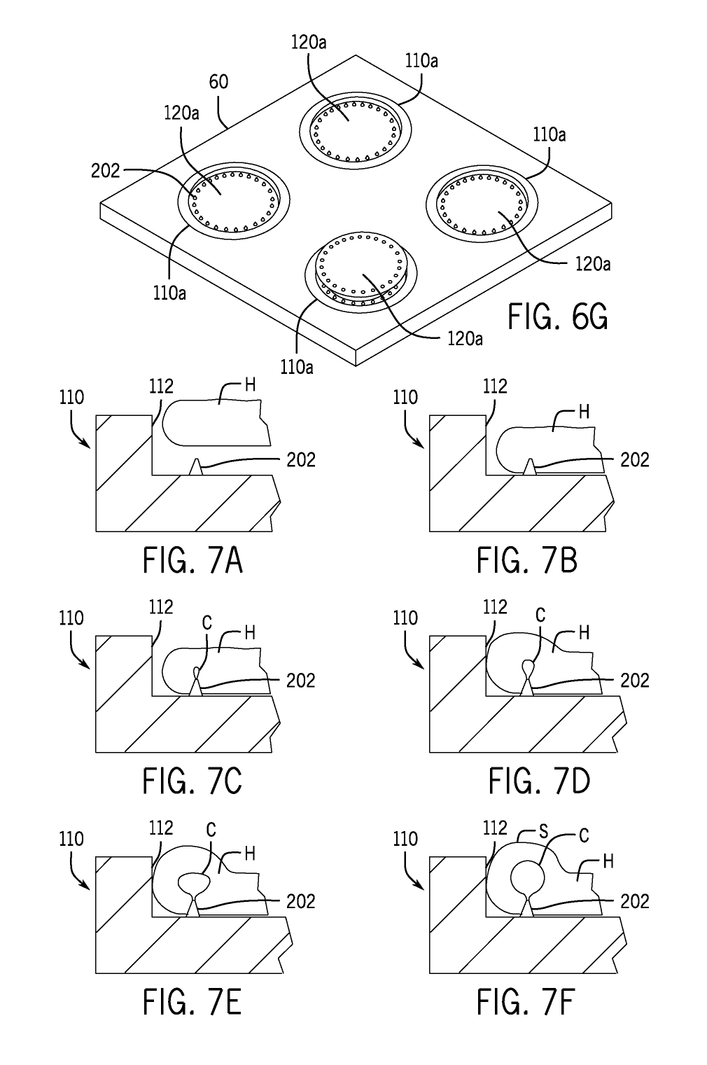

As shown schematically in FIGS. 6A-B, the size and shape of the fixture may be adapted to the size and shape of the shell; the fixture may be circular (FIG. 6A) or rectangular (FIG. 6B); according to other exemplary embodiments, the fixture may have any of a variety of different shapes (and sizes) matched to the shape (and size) of the desired pizza shell. According to exemplary and other embodiments, the apparatus to form the pizza shell (e.g. including fixtures and tooling) may be designed and configured or reconfigurable (e.g. with interchangeable components) to allow the production of a pizza shell having various selected forms and shapes/sizes at the facility where the pizza product is produced.

As indicated, the fixture may be provided with a lifter plate 120 that is retracted (see FIGS. 6C and 6E) and extended (see FIGS. 6D and 6F) to allow the pizza shell H to be seated in the fixture and filled (e.g. when retracted) and to be separated from the fixture (e.g. when extended) and sent to another station or operation. As shown in FIG. 6G, according to an alternative embodiment, a filling station shown as system 60 may comprise multiple fixtures 110a (e.g. as to allow mass production of pizza products as in a commercial or institutional facility). As shown, for example, each fixture may provide a lifter plate 120a; as shown, the lifter plate can be configured with a set of holes or apertures to fit substantially over the corresponding ports (e.g. as to have the plate provide a more complete support structure beneath the shell and to reduce or prevent deflection or drooping of the edges of the shell); as shown, the ports 202 project through the holes of the plate 120a.

Referring to FIGS. 7A-7F, operation of the station forming the dough component of the shell with air to form each cavity of the set of cavities is shown schematically according to an exemplary embodiment. The shell H is placed within the fixture 110 of the station (FIG. 7A) and fitted onto the ports 202 within the side walls 112 of the fixture 110 as the ports 202 enter (e.g. penetrate or puncture) the bottom surface of the shell (FIG. 7B). A supply of gas (e.g. pressurized air or equivalent) from a plenum and manifold (see, e.g., FIG. 4C) is provided through ports 202 which begins to inflate the shell to form cavity C in the exterior edge of the shell H (FIG. 7C) at each port and the effect of continuing supply of the gas is the inflation in the shell H at each port with a pocket of gas that forms and expands the cavity C-(FIG. 7D); as indicated schematically, as inflation of the shell H and expansion of the cavity C continues, the edge of the shell is enlarged and bulges outward into side walls 112 of the fixture 110 while also bulging upward (FIG. 7E) to form the segment of the shell that (when the final product is baked) forms a crust S with a cavity C at the location of each port 202 of the fixture 110 (FIG. 7F).

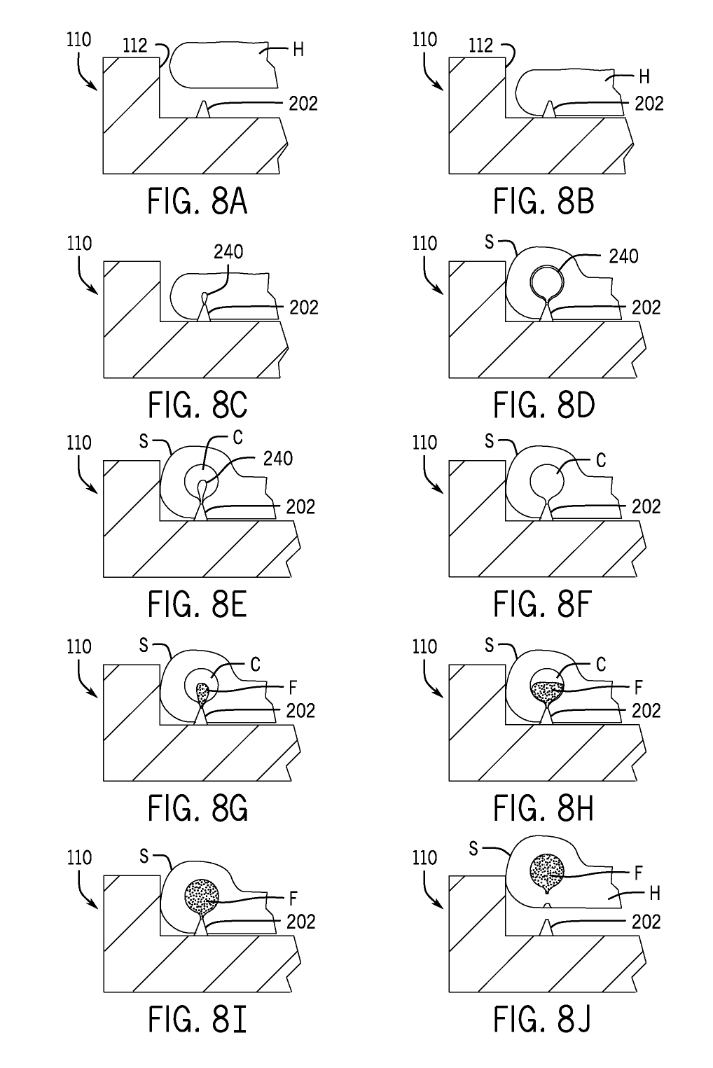

Referring to FIGS. 8A-8J, the operation of the station forming the dough component of the shell intended to provide the crust segment with each cavity filled with fill component of the set of filled components is shown schematically according to an exemplary embodiment. The shell H is placed within the fixture 110 at the station (FIG. 8A) and fitted onto the ports 202 within the side walls 112 of the fixture 110 as the ports 202 enter (e.g. penetrate or puncture) the bottom surface of the shell (FIG. 8B). An inflatable bladder shown as balloon 240 initially contained within each port 202 is inflated with a gas (e.g. air) and expands out of an outlet of port 202 and inflates within the dough component of the shell to form and enlarge a cavity C at each port (and to establish the enlarged form and shape of the crust segment S in fixture 110) (see FIGS. 8C and 8D); the balloon 240 is then deflated and retracted into port 202 leaving the cavity C in the shell (see FIGS. 8E and 8F). The fill component F is then supplied (e.g. injected under pressure) into the cavity C through an outlet in each port 202 (see FIGS. 8G-8I). When the cavity C at each port has been suitably filled with fill material F the shell H with crust segment S is removed (e.g. lifted) from the fixture 110 (FIG. 8J).

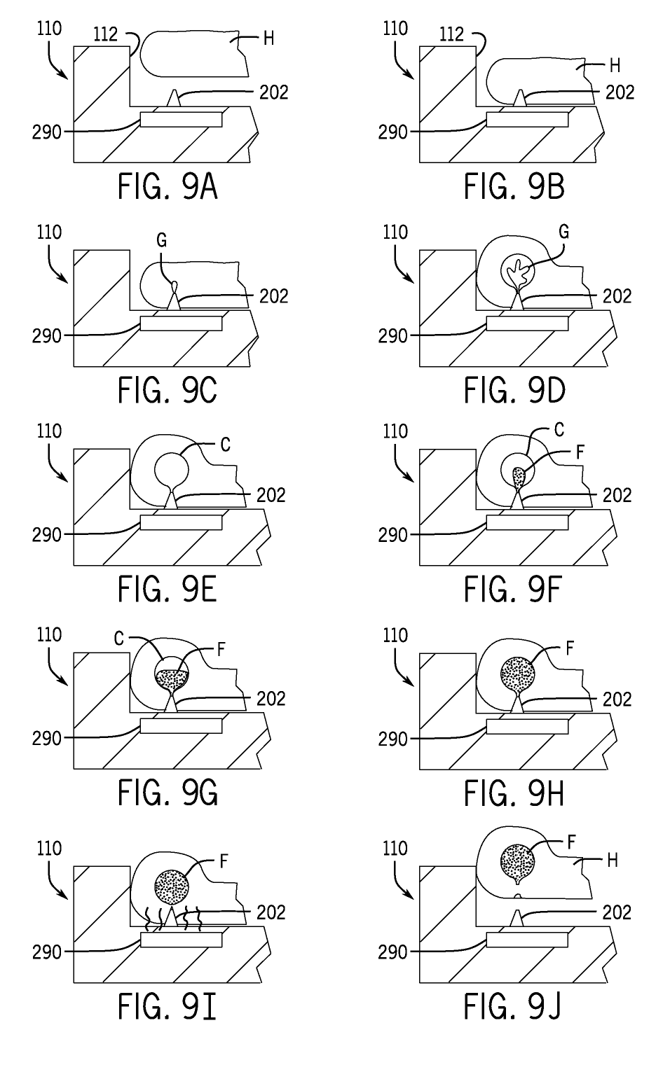

According to an alternative embodiment shown in FIGS. 9A-9J, the station can be configured so that the cavity within the dough component of the shell intended to form the crust segment is formed with a gas (e.g. compressed air or nitrogen) or vapor (e.g. steam). As indicated in FIGS. 9C-9D, after the shell has been seated within the fixture 110 on ports 202, the vapor or gas G is injected through an outlet in each port 202 into the dough component to form the cavity C at each port, as indicated in FIGS. 9F-9G, each cavity C is then filled with the fill component F by injection through an outlet in each port 202. According to an exemplary embodiment, the station may also comprise a thermal element 290 (shown schematically) to facilitate the sealing or a “set” in the dough component after formation of the cavity (e.g. if no fill material is to be added) and/or after fill component has been provided (e.g. to at least partially close or seal the opening in the dough component formed by the puncture of the port.) As indicated (schematically) in FIG. 9I, the thermal element 290 is configured as a heat exchanger operating adjacent to the bottom of the dough component of the shell that is penetrated or punctured by each port 202. According to one exemplary embodiment, the thermal element applies heat to “set” the dough component and/or fill material at the localized area (e.g. by par-baking); according to another exemplary embodiment, the thermal port element is a cooling element configured to “set” the dough component and/or fill material at the localized area (e.g. by quick-freezing). According to a preferred embodiment, the shell with the “set” dough component and/or fill material will tend to retain shape and hold fill material (if any) as transported or processed into a product at subsequent operations and stations (e.g. to prevent or reduce deformation or leakage). As indicated, a pizza product with the shell formed to have set cavities may have the cavities filled at or just before the time the pizza product is finished for consumption (e.g. with empty cavities being filled with a fill material of choice by a consumer preparing the pizza product to be baked and consumed).

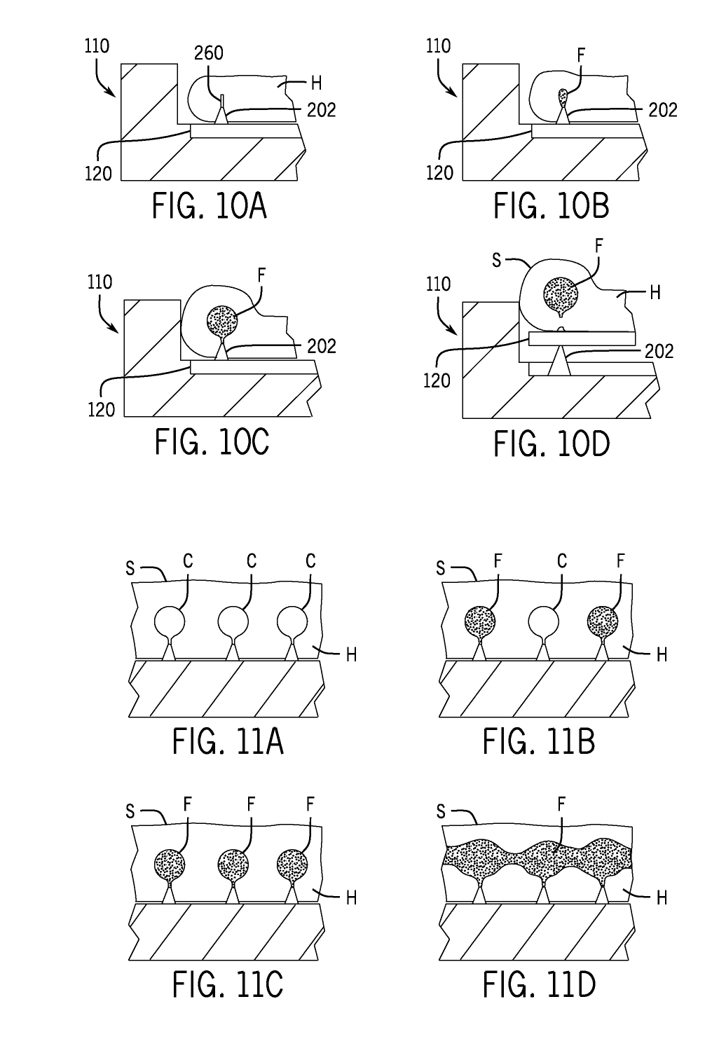

As shown schematically in FIGS. 10A-10D, according to an exemplary embodiment, the dough component of the shell H intended to form the crust segment S may be filled and formed directly with the fill component F supplied through an outlet in each port 202. According to an exemplary embodiment, the station may comprise a lifter plate 120 that fits over each port 202 and under the edge of the shell to provide support for the shell to be removed (e.g. lifted) from the fixture (see also FIG. 6G).

As indicated in FIGS. 11A to 11D, according to exemplary embodiments, the fill and cavity arrangement for the shell and crust may vary in type and form. According to alternative embodiments, the station may be configured to provide a set of cavities and or filled cavities in a specified pattern or arrangement (e.g. of differing fill materials, sizes, etc.) For example, as shown in FIG. 11A, multiple (or all) cavities may be open (e.g. as empty or air-filled pockets); as shown in FIG. 11B, the shell and crust may have a designated pattern of open cavities and filled cavities; as shown in FIG. 11C, multiple (or all) cavities may be filled (e.g. each with the same fill material or with different fill materials in a pattern). As shown in FIG. 11D, cavities may be “overfilled” (e.g. enlarged in size) in a manner that will establish in the dough component continuity between multiple cavities (e.g. with some or all individual cavities no longer discrete or separate from each other). According to other exemplary embodiments, the cavities may be provided in different sizes (and/or at different spacing) and/or filled with different fill components (e.g. alternating pizza sauce and cheese or other material) or with different mass/volume of fill component within a shell or for various types of configuration of shells. As indicated, according to alternative embodiments, the station may be configured to produce a shell that has any of a wide variety of fill/cavity arrangements; various other alternative embodiments of the station combining some or all of the indicated features and mechanisms may be provided as suitable for particular uses and applications (e.g. at the station different tools and fixtures may be adapted or interchanged to produce different arrangements and/or products as desired).

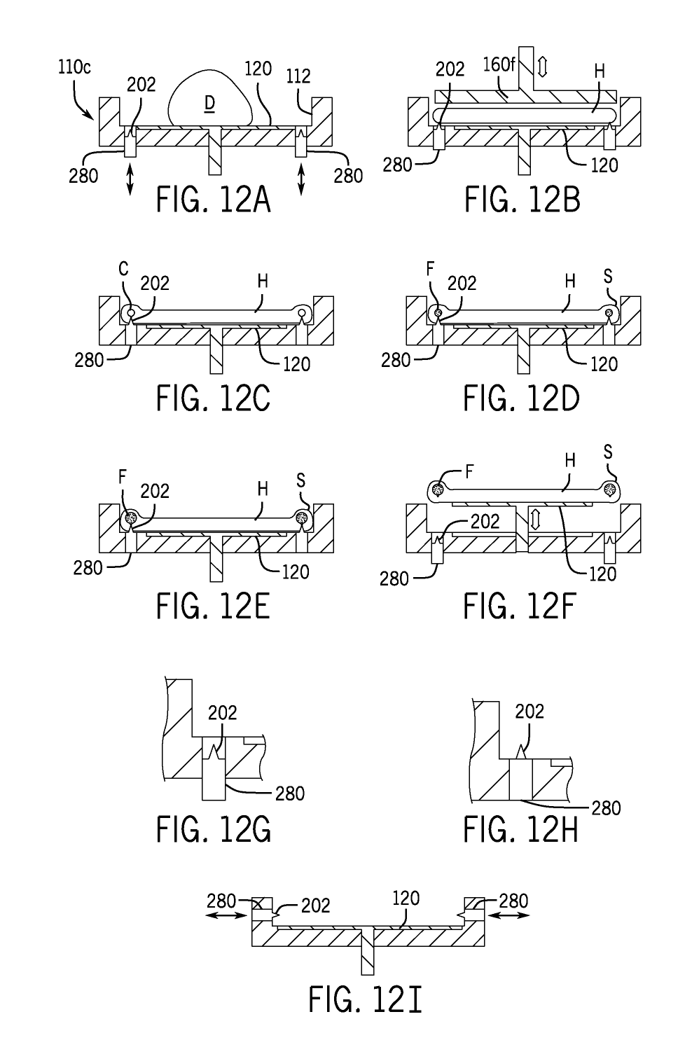

As shown schematically in FIGS. 12A-12I, the station may be configured so that the ports for the fill/injection are moveable to engage and disengage the dough component of the shell within the fixture. As shown in FIGS. 12A-12B, a dough component shown as a dough ball for the shell may be dispensed into the fixture 110 within side walls 112 on top of the lifter plate 120 (FIG. 12A) and then flattened/formed by a tool 160f into the shape (e.g. desired form) of the shell H. As shown in FIGS. 12C-12E, outlets of ports 202 are on a mechanism 280 (shown schematically) that initially is retracted but then is deployed to puncture the surface of the dough component of the shell intended to be the formed crust S; when deployed, the outlets of the ports may supply a gas or vapor to form a cavity C and/or a fill component F (e.g. into or to form a filled cavity); the mechanism 280 then retracts (e.g. as at the start of the operation). See also FIGS. 12G and 12H. The shell H with the formed and/or filled cavity arrangement of the crust segment S can then be removed from the fixture (e.g. lifted by plate 120). As shown schematically in FIG. 12I, according to an alternative embodiment, the fixture for the station can be configured so that the mechanism 280 deploys the ports 202 through the side walls from a side or lateral direction (for the forming and/or filling operation to have a side entry into the dough component of the shell). (As indicated, the tool and fixture configuration may be interchanged in the station and the operating program or protocol adapted in the production facility depending upon the product or arrangement to be produced.)

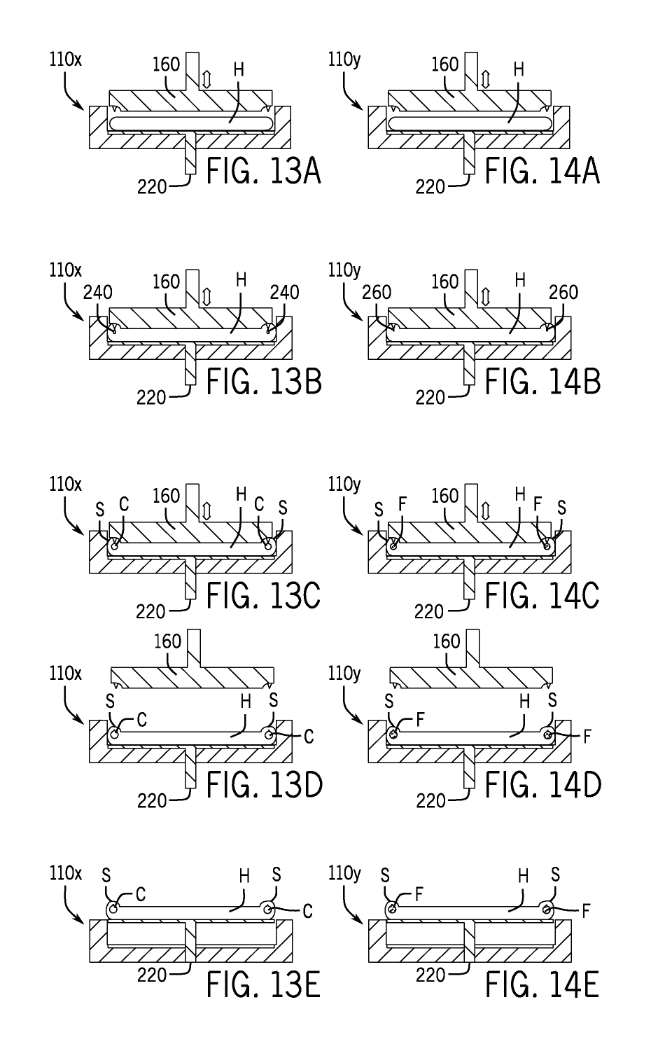

According to alternative embodiments shown schematically in FIGS. 13A-13E and 14A-14E, the station can be configured so that the mechanism with ports 202 (and outlets) for forming/filling cavities in the dough component of the shell H as intended for the crust segment S is on a tool (e.g. forming tool) that engages (e.g. flattens/forms and punctures) the dough component of the shell from the top. As shown in FIGS. 13A-13C, the mechanism 240 can be configured to engage the dough component (and supply gas/vapor) to form a cavity C in the shell; as shown in FIGS. 14A-14C, the mechanism 260 can be configured to engage the dough component and supply a fill component to form/fill a filled cavity F. The tool with the mechanism can then be retracted and the formed and/or filled shell can be removed from the fixture of the station (e.g. lifted by plate 220) as shown schematically in FIGS. 13D-13E and 14D-14E.

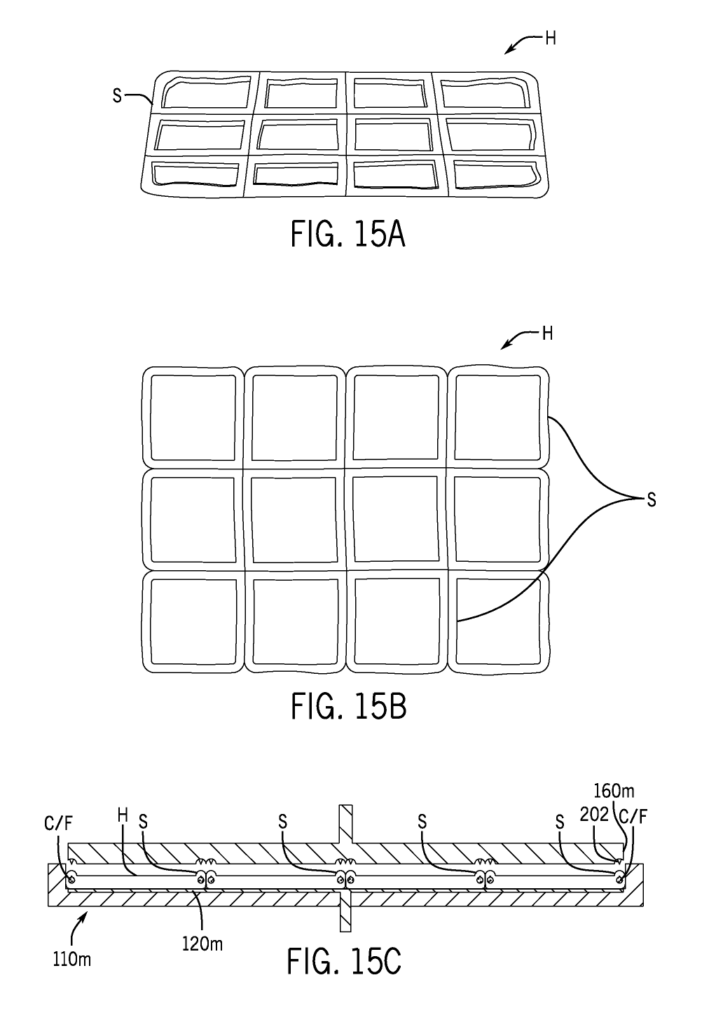

As shown schematically in FIGS. 15A-15C, according to an alternative embodiment, the station can be configured to produce a shell H for a pizza in which the dough component is segmented by internal crust segments S in addition to external crust segments S. A system (e.g., fixture and tool arrangement) configured to form (and fill) a dough component the shell H with multiple segments of crust S (internal and external) is shown according to an exemplary embodiment in FIG. 15C. The system comprises a fixture 100m with a tool 160m. As indicated, ports 202 with outlets for forming/filling cavities C/F in the crust segment S of the dough component of the shell H are positioned in a pattern or array on the tool 160m (e.g. in an arrangement configured to provide the desired spacing and pattern of cavities in the shell). (According to an alternative embodiment, the ports or array of ports can be provided on the fixture base rather than on the tool, see, e.g. FIG. 6G.) The dough component for the shell is formed in the fixture by tool 160 lowered into the dough component to establish the form (e.g. imprint) the segments for crust S (see FIGS. 15A-15B) and then at each port 202 according to the specified process gas/vapor (to form cavity C) and/or fill component (to form filled cavity F) is supplied into the dough component at the segment for crust S. The tool 160 is then raised and disengaged (e.g. separated) from the shell; the shell is removed from the fixture by plate 120 (e.g. lifted from the fixture). The shell with formed/filled cavities in the crust segment is then conveyed to the next station for further processing. As indicated in FIGS. 15A and 15B, the resultant pizza product will provide external and internal crust segments that are configured to facilitate convenient handling and division (e.g. slicing or breaking/tearing) at the time of preparation and consumption of the pizza product.

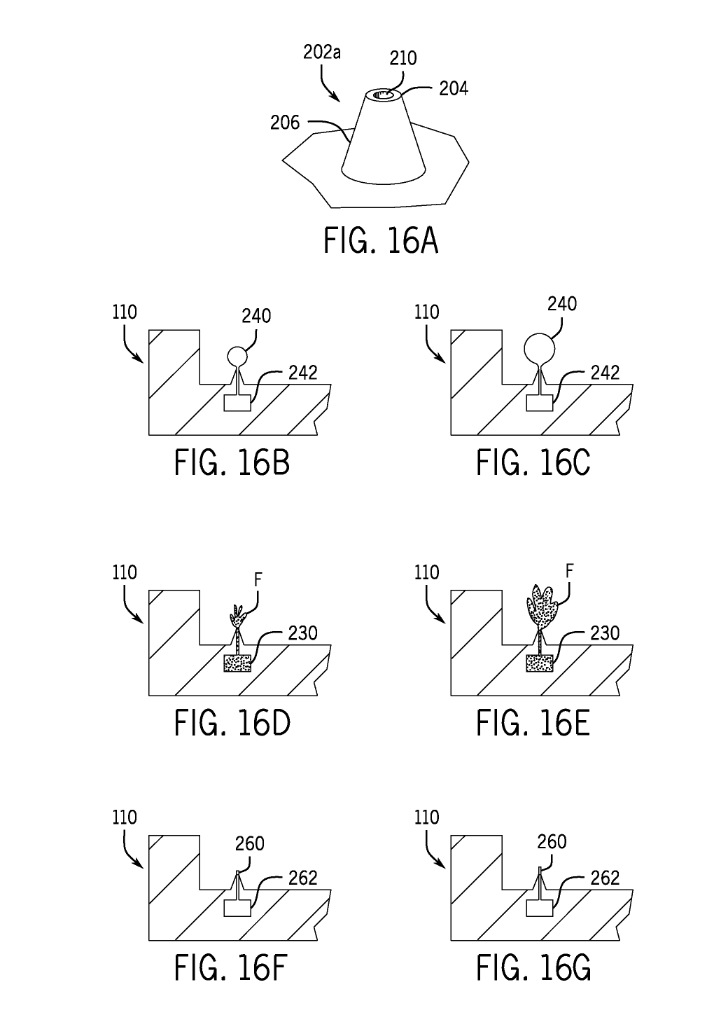

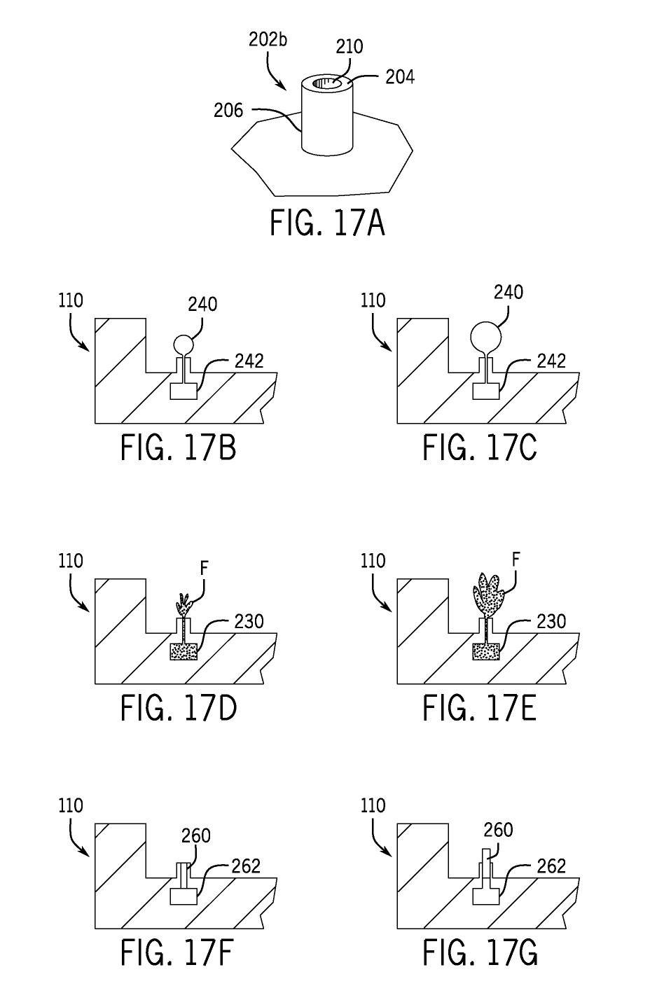

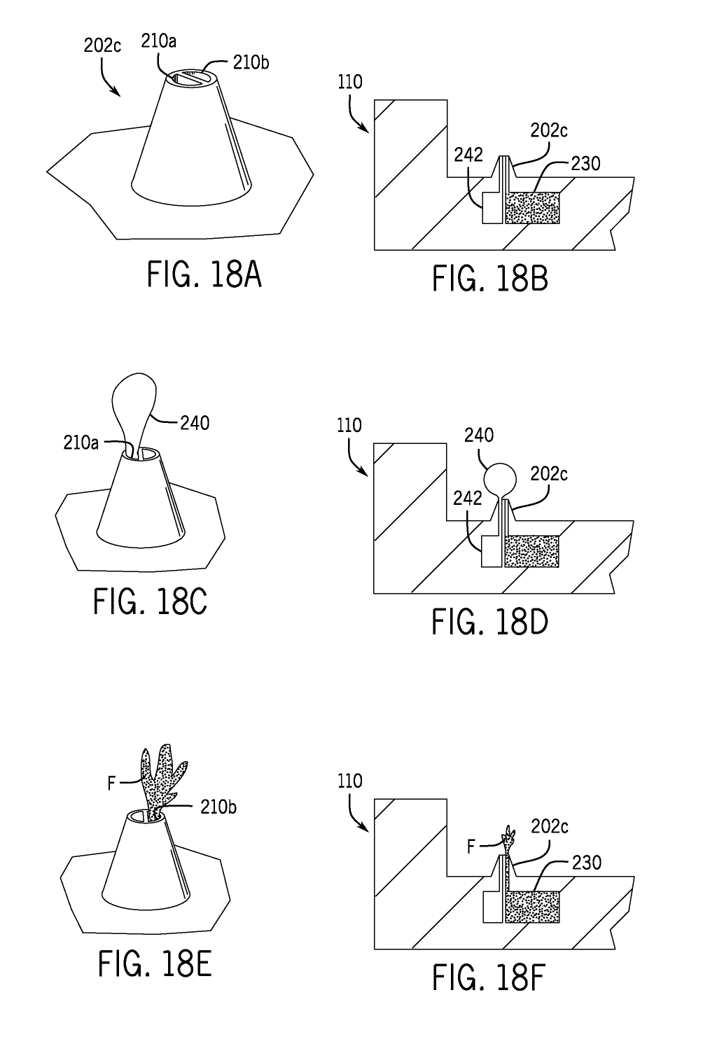

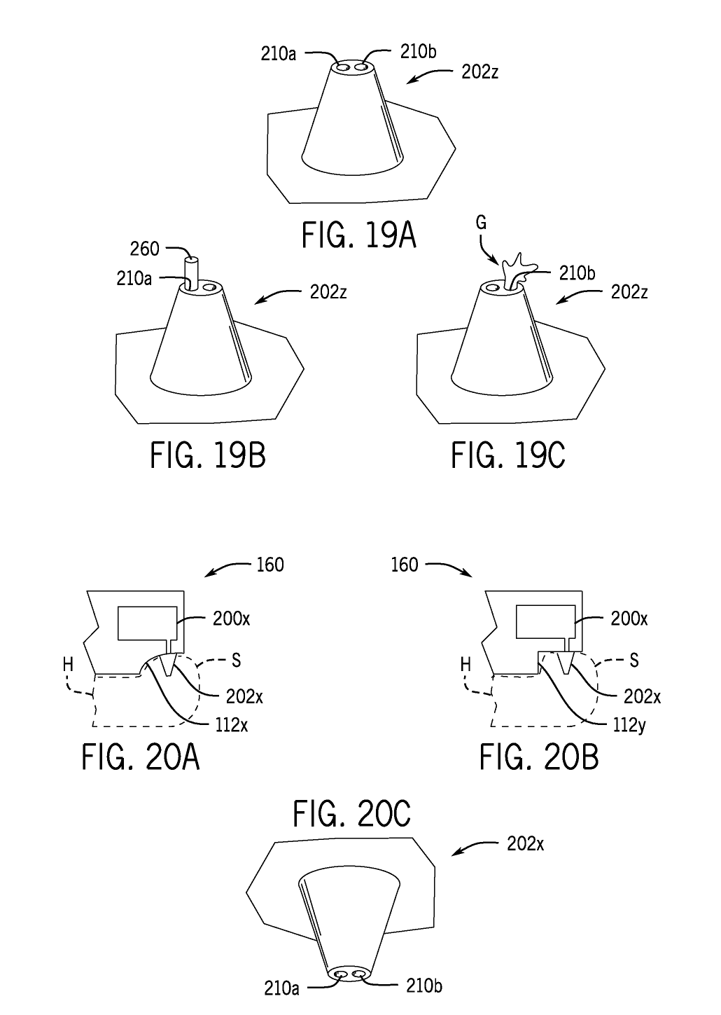

Configurations of the port and outlet arrangement for the station are shown schematically according to exemplary embodiments in FIGS. 16A-16G, 17A-17G and 18A-18F. As shown in FIG. 13A, the ports 202a may be provided with a generally frusto-conical shape having a base 206 and a top 204 and a central outlet 210 through which the forming/filling operation may be executed, for example, by deployment of an inflatable bladder or balloon 240 from a mechanism 242 (see FIGS. 16B-16C), by supply of a fluid shown as component F pumped or injected under suitable pressure from a chamber or reservoir shown as plenum or tank 230 (see FIGS. 16D-16E), by a tool shown as a mandrel 260 deployed from and retracted into a mechanism 262 (see FIGS. 16F-16G). As shown schematically in FIGS. 17A-17G, according to an exemplary embodiment, the station may provide the port 202b in a generally cylindrical form. (As indicated, according to alternative embodiments the ports may be provided on interchangeable tools and fixtures or other apparatus in any of a wide variety of forms or combinations of forms and patterns and arrangements with or without associated mechanisms.) As shown schematically in FIGS. 18A-18F, according to an exemplary embodiment, the station may provide a port 202c having multiple outlets shown as outlet 210a and outlet 210b. As shown in FIGS. 18A-18F, the outlets may be configured to perform different or sequential operations or functions at the station (e.g. under the direction of a control system, controller or network-based system, etc.). For example, as shown in FIG. 18C, outlet 210a may be configured to deploy the bladder or balloon 240 from a mechanism 242 to form a cavity. As shown in FIG. 18E, outlet 210b can be used to supply fill component F from a chamber shown as plenum 230 to fill a cavity. As indicated in FIGS. 18D and 18F, according to an exemplary embodiment, the port with multiple outlets may operate in a sequence in which one outlet is used to form a cavity and the other outlet is used to fill the cavity with a fill component. As shown in FIGS. 19A-19C, according to an exemplary embodiment, each of the outlets of a port 202z may be provided in a circular cross-section; the outlets may be configured to deploy a tool 260 (shown as a mandrel) to form or start a cavity or a gas or vapor G (e.g. air, nitrogen, nitrous oxide, carbon dioxide or another gas under pressure or vapor such as steam) to form or start a cavity (which then can be filled with a fill component or left open/empty). See also FIG. 20C. As indicated, the sequence of operations in the production of the shell can be modified as desired in the forming/filling of the cavities according to various exemplary and alternative embodiments.

Referring to FIGS. 20A and 20B, a tool 160 may be configured to facilitate the formation of the dough component of the shell H for the crust segment S from the top direction with port 202x into a rounded form (FIG. 20A) or into notched form (FIG. 20B). As indicated schematically, the tool 160 may include a plenum (tank 200x) chamber for supply of the fluid (e.g. gas or fill component) or mechanism used to form and/or the supply of fill material to fill the cavity in the shell H for crust S. As indicated in FIG. 20C, the port 200x may be configured to provide multiple outlets to form and/or fill a cavity or filled cavity. As indicated, tools or fixtures may be modified or interchanged (and/or operated in a different manner or sequence) at the station to produce different arrangements, shapes, forms, patterns effects etc. in the product.

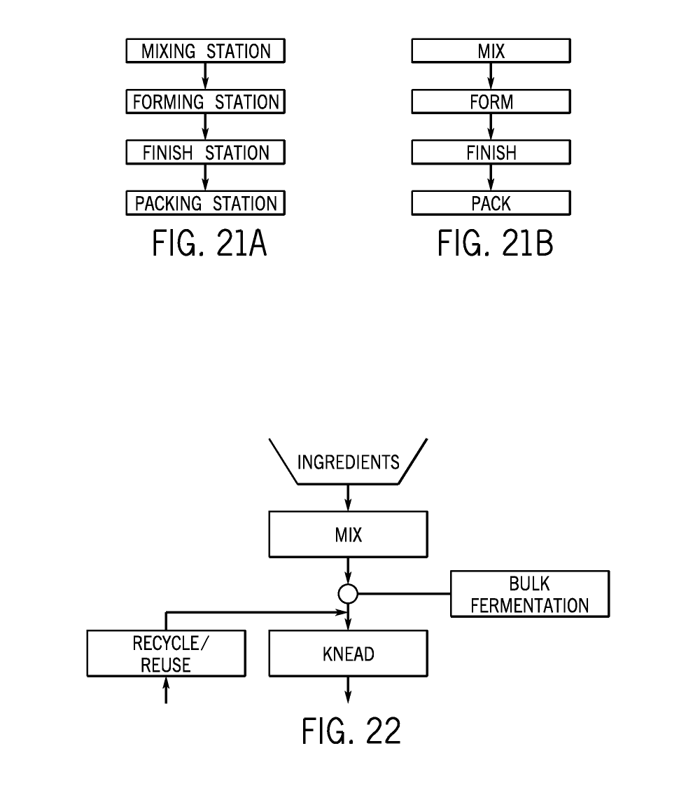

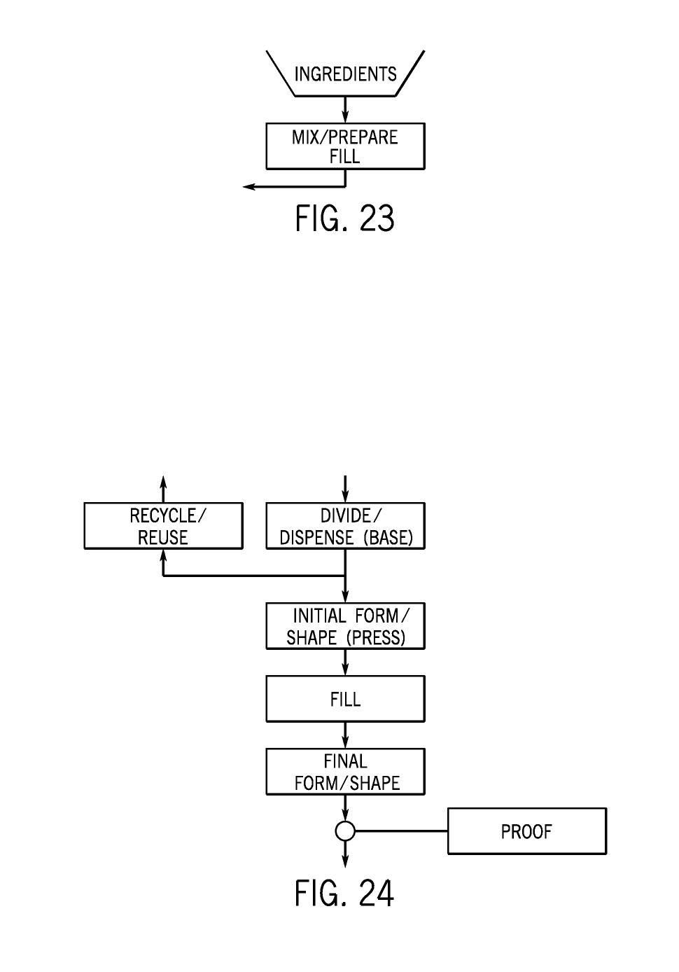

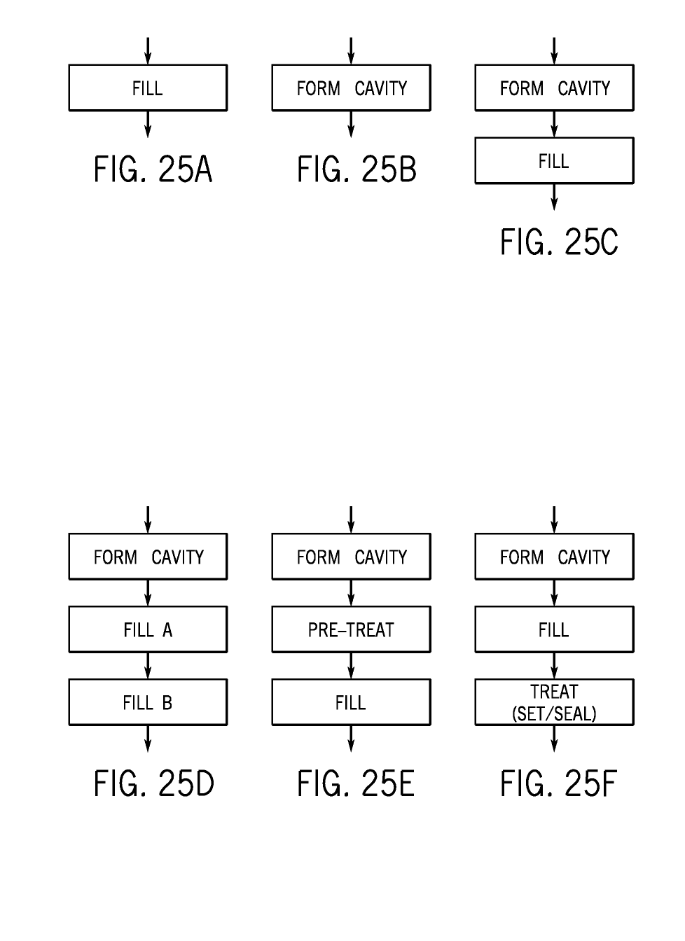

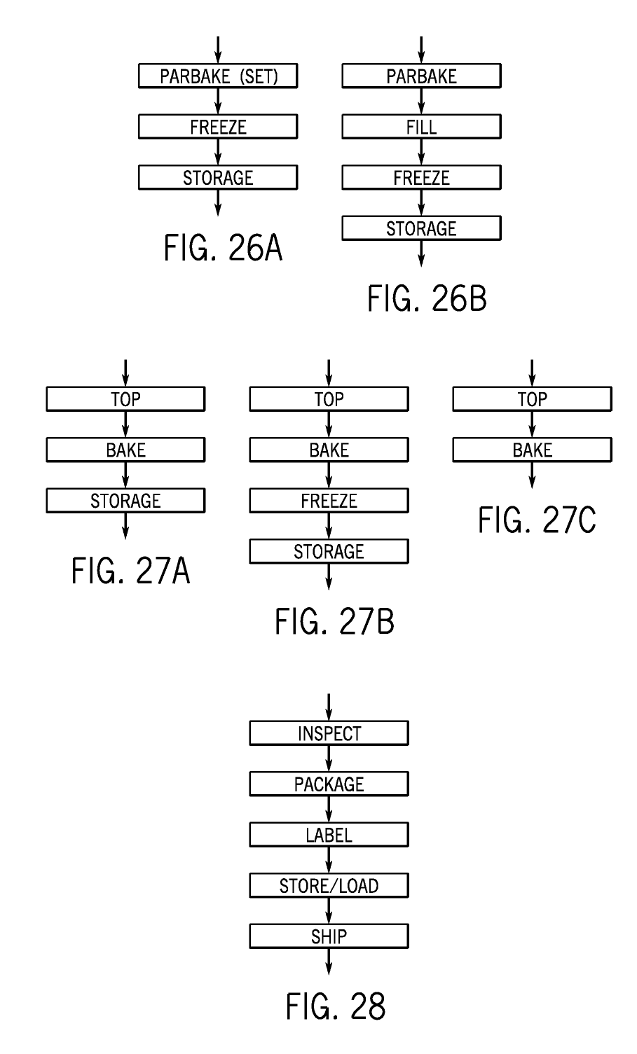

Exemplary embodiments of systems and methods to produce the pizza/shell product are shown schematically in FIGS. 21A to 28. Referring to FIGS. 21A and 21B, the system and method comprises a set of stations: ingredients for the dough component of the shell (and the fill material) are mixed at a mixing station (see FIGS. 22 and 23); the dough component is formed into the shell with cavities or filled cavities at a forming station (see FIGS. 24 and 25A-25F; the shell is finished into a product (e.g. a pizza shell product, a pizza with toppings, etc.) at a finishing station (see FIGS. 26A-26B and 27A-27C); the finished product for commercial distribution is prepared, inspected/photographed, packed and/or packaged for shipment, transport, sale, consumption, use etc. at a packing station. According to a preferred embodiment, the system may be configured so that the stations are computer-controlled and networked (see FIG. 21A) and the system and method can be implemented in a commercial production facility. According to a particularly preferred embodiment, the forming station can be configured and controlled so that a variety of different products can be produced at the station (e.g. having a variety of different arrangement of cavities and/or filled cavities, etc.) as directed by a control program. According to any preferred embodiment, the system will facilitate the efficient production of pizza products for commercial sale and distribution.

An exemplary embodiment of the mix process for a dough component of the pizza shell product is shown in FIG. 22. Ingredients for the dough component (e.g. flour, water, etc. to suit the intended recipe or formulation) are mixed and (optionally allowed time for bulk fermentation/proofing) worked (e.g. by conventional or other methods such as kneading) into condition for the next station/process operation of forming. As indicated portions of the dough component recovered from subsequent process operations or stations may be recovered and recycled/reused by recombination with the dough component newly mixed from ingredients. The fill component (if any) can be mixed from ingredients and prepared for dispensing at the forming station, as indicated in FIG. 23.

Exemplary embodiments of the forming process for the dough component of the pizza/shell product are shown in FIGS. 24 and 25A-25F. As indicated in FIG. 24, the dough component for the shell may after mixing and working be dispensed and then formed and shaped initially for subsequent processing including the formation and filling of the cavities which may bring the shell into the final form or shape.

As shown in FIGS. 25A-25F, the forming operation may comprise various steps and combinations of steps in various sequences according to exemplary embodiments. For example, after the dough component of the shell has been dispensed, the fill component may be supplied directly (e.g. injected under pressure) to the form the multi-component bread product (FIG. 25A); a cavity may be formed to form a shell with cavity (see FIG. 25B), a cavity may be formed and then filled with a fill component to form a shell with filled cavities (FIG. 25C), a cavity may be formed and then filled with a first fill component A and a second fill component B to form a multi-fill component shell (FIG. 25D); a cavity may be formed and then pre-treated (e.g. provided with application of heat or with an additive or ingredient to produce a desired effect such as a “set” to the cavity) and then filled with a fill component (FIG. 25E); to produce the shell; a cavity may be formed and filled with a fill material and then treated to “set” the dough component to retain the shape (and to prevent leakage of the fill) for example by application of heat or freezing the dough component/fill material at the localized are (FIG. 25F). As indicated, according to other exemplary and alternative embodiments, there may be a wide variety of adjustments and adaptations to the process, for example, including the formation of multiple cavities and/or fill segments within the pizza/shell product. As indicated, according to any preferred embodiment, the system can be configured with adaptable and/or interchangeable tools and fixtures and operated with a control program that will conveniently and efficiently facilitate the production of a variety of different products and arrangements having a variety of different forms at the same facility or station.

According to an alternative embodiment, the pizza shell product may (after cavities have been formed) be par-baked and then fill component may be supplied and then the pizza shell product with filled cavities can be frozen and prepared/stored for transport and use (to be used to prepare a pizza). As indicated, variations of the process steps may be implemented according to exemplary and alternative embodiments.

According to other exemplary embodiments, the dough component may be heated during the forming/filling operation. The application of heat may facilitate the formation of the cavity by enhancing the relevant properties of the dough component and/or by causing the cavity to be “set” into the dough component (i.e. so that the dough component maintains the cavity after formation). As indicated, heat can enhance the workability of the dough component at the step of the cavity formation and/or the workability of the fill component at the step of filling.

As shown in FIGS. 26A-26B and 27A-27C, according to exemplary embodiments, a finished pizza/shell product for use, sale and/or consumption can be produced after the dough component (single or multi-component) has been formed. According to an exemplary embodiment, a finished pizza/shell product will by formed by par-baking and then and then storing or transporting the product (e.g. pizza shell as intended for use, sale and consumption (see FIG. 26A).

According to other exemplary embodiments, finishing the product may comprise other steps or combinations and sequences of steps. For example, the product may be topped and baked and stored and/or transported for the next use (see FIG. 27A), topped and baked and frozen for storage/transport (see FIG. 27B), or topped and baked for use and consumption (see FIG. 27C). As indicated, according to exemplary embodiments, the finished product may be a frozen (or refrigerated) product for subsequent baking into a baked pizza product at a later time by a customer or another person or entity or may be a baked pizza product ready for use and consumption (or any variation as required for the intended purpose). Referring to FIG. 28, the final/finished product can according to an exemplary embodiment be completed for use and sale by inspection for defects of any kind, packaging and labeling, storage and loading for shipment and shipment or delivery to the intended user or outlet. As indicated, the steps to complete the product will vary with the type of product (e.g. pizza/shell, baked pizza, frozen pizza, refrigerated pizza, etc.) and the intended use or uses of the product (including, for example, the proximity to the production facility). According to one exemplary embodiment, the system can be implemented at a commercial/institutional or retail facility such as a supermarket/superstore, restaurant, food service facility or cafeteria, institution providing food service, etc. where the finished pizza/shell product is sold or served for consumption. According to another exemplary embodiment, the system can be implemented at a production facility and the finished pizza/shell product packaged and shipped to a commercial/institutional or retail facilities.

According to exemplary and other embodiments, the system and method can be adapted (in whole or in part or parts) to be incorporated in improvements of any of a wide variety of known/conventional and other production systems and methods currently in use in the production of pizza products. For example, apparatus of the system and method (e.g. including any fixture/tool or station as shown in the FIGURES) may be adapted and/or installed and included in improvements of existing/in-use or future-developed systems and methods of manufacturing pizza products so that such pizza products may be produced in an improved form and manner (e.g. including any pizza product as shown in the FIGURES) according to exemplary and other embodiments. According to an exemplary embodiment, an existing or future system and method for producing pizza products from a pizza shell may be adapted and modified/improved to include an apparatus to form cavities/segments and/or filled cavities/sections in the pizza shell so that the pizza products when finished have filled crust segments (see, e.g., FIGS. 2A-2B and 11A-11D) or interior crust segments (see, e.g., FIGS. 15A-15B) or a filled interior section (see, e.g., FIGS. 31A-31B).

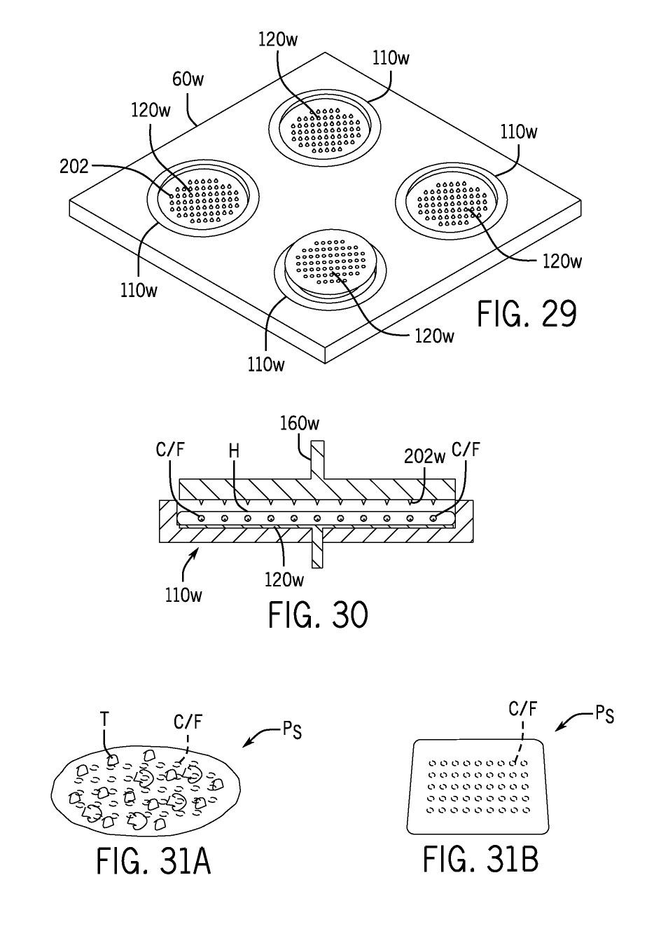

Referring to FIGS. 29-31B, a system and method of producing a pizza-like product Ps is shown according to an alternative embodiment. As shown schematically in FIGS. 30 and 31A-31B, the product is formed from a dough component or shell and comprises a center section that has a plurality of cavities which can be filled with various types of fill components (and/or can be empty cavities) in a designated pattern or arrangement. (The edge (or crust) of the product as shown schematically in FIGS. 31A and 31B according to exemplary embodiments does not include the cavities that are in the center portion.) The product can be filled at a station with an apparatus as shown in FIG. 29 (e.g. from the bottom) or as shown in FIG. 30 (e.g. from the top) or according to an alternative embodiment (e.g. a combination or other arrangement). As shown in FIG. 29, the apparatus may comprise a base 60w with multiple fixtures 110w shown with ports 202w (for forming/filling cavities) and plates shown as lifter plates 120w having holes that fit over ports 202w. As shown in FIG. 30, the apparatus may comprise a fixture 110w with a forming tool 160w providing ports 202w (for forming/filling cavities) and a lifter plate 120w. As indicated in FIGS. 29 and 30, the lifter plates 120w are used for removing the shell H after forming/filling into the product.

As shown in FIGS. 31A-31B, the pizza product Ps has an arrangement of cavities and/or filled cavities in the center area and can be provided in a round shape (FIG. 31A) or rectangular shape (FIG. 31B) or according to alternative embodiments in various other shapes. Toppings T may (optionally) be applied to the product in the finishing operation as indicated in FIG. 31A. The resultant product may be commercially produced and sold as a baked pizza product or as a frozen pizza product or as a refrigerated pizza product according to exemplary embodiments. See generally FIGS. 21A-28.

As indicated, according to alternative embodiments, the system and method may be configured to produce any of a wide variety of types (e.g. shapes, sizes, patterns) of pizza products having a wide variety of types (e.g. shapes, sizes, patterns) of cavities within the dough component of the shell. For example, according to alternative embodiments, the apparatus to form the pizza shell may be configured so that the size of the cavities within a specific pizza product may be varied in size or form (or fill) within the shell; one apparatus may be configured to form cavities of a first size and another apparatus may be configured to form cavities of a second size (e.g. larger or smaller than the first size); the apparatus maybe interchanged based on a determination as to the size of cavities to be formed. According to another alternative embodiment, the apparatus maybe configured to form different patterns or arrangements of cavities (e.g. different locations, spatial relationships, spacing, size, shape, etc.) as suitable for the type of pizza shell and/or type of crust intended to be formed. The dough component of a pizza crust may be formed into the shell in a pan or fixture in which injection sites or injectors (ports) may are provided as to protrude into the dough component of the pizza shell. The sites of the injectors or ports may be (for example) located around the perimeter of the dough component of the shell or within an interior region of the dough component of the shell or in another pattern or combined form. The fluid (such as air) to form or maintain the cavities air may be injected through the injectors or ports into the interior of the dough component at the edge of the shell where the crust would form thereby creating a cavity within which may be stored any of a variety of fill materials. The forming and/or filling of the cavities may be performed at any time during the production including during finishing (baking) of the pizza product.

### Example Formulation of Dough Components

Specific formulations of the dough component (or dough components) for the shell of a pizza product according to exemplary embodiments can be determined by the type of shell intended to be produced and desired characteristics intended to be obtained in the shell. According to any exemplary embodiment, formulations of a dough component may be adjusted or adapted for particular purposes as determined by the situation or need. As also understood to those of skill in the art, independent of the specific formulations of the dough components, other factors can affect the texture or flavor of a pizza shell, for example, mixing techniques, fermentation time, and the operating conditions of the baking/cooking procedure.

According to any preferred embodiment, the dough component may be formulated to produce desired effects in the finished pizza product, such as flavor, aroma, texture, consistency, color, shape, size, mass/density, shelf-life, etc. The shell of a pizza product provides structure for toppings and/or fill material and generally as the pizza product is handled and consumed. The dough component for the shell of the pizza product may also be formulated for compatibility with the toppings and/or fill material (e.g. including for baking/cooking and for taste/texture) as well as to achieve a suitable shelf life and/or storage time (e.g. including storage time in a freezer or refrigerator).

Formulations for the dough components are expressed (by weight) in what is called a “baker's percentage” where the flour (or type of flour) that makes up the bulk of the formula is expressed as 100 percent (one unit) and all other ingredients are scale-based (by weight) on the unit of flour of the formulation of the dough component.

According to exemplary and other embodiments, the dough component formulated for a pizza shell may comprise any of a wide variety of base ingredients and optional ingredients in a wide variety of combinations (see, e.g., ingredients listed in TABLES 1 and 2). As indicated, the percentages of each ingredient for a particular formulation of dough component may be adjusted within ranges, for example, for suitability to the operating conditions for baking the pizza product; various substitutions may also be employed for certain ingredients as or if necessary or appropriate for the formulation of the dough component for a pizza product.

Flour and water with a suitable amount of salt mixed to a suitable consistency will generally formulate a dough component suitable to produce pizza products using the processes outlined in the exemplary embodiments. Other functional ingredient such as improvers and additives and garnishes, etc., may also be included in the formulation of the dough component for a pizza product. Pre-hydrated starches and flours and flavorful liquids (instead of pure water) could be used according to other exemplary embodiments of a dough composition. According to any preferred embodiment, the dough component will be formulated to withstand the processes while yielding a baked pizza product that is flavorful and functional for the intended purpose.

Other tools and techniques could be employed to affect and alter the flavor and texture of the finished pizza product made from the dough components. For example, according to exemplary embodiments, part of the mix of ingredients of the dough components could be pre-gelatinized, additives and garnishes (e.g. nuts, cheese, dry fruit, etc.); other known means for adjusting or improving the blend of flour and ingredients in a dough component could be used. As known to those of skill in the art, there are a wide range of ingredients and options for formulating a suitable dough component or dough components; no suitable formulation of dough component for a pizza product is intended to be excluded according to the exemplary embodiments.

### Example A

To provide a rich or dense enriched dough component for pizza product an example formulation may comprise the formulation shown in TABLE 1. As indicated, the percentages of each ingredient may be adjusted within ranges and to suit the operating conditions for baking the bread product; suitable substitutions may also be employed for certain ingredients as or if necessary or appropriate.

### Other Ingredients/Improvers/Variations

According to other exemplary embodiments, as indicated, the formulation of ingredients for the dough component of pizza products (including the type or source of flour) and various other ingredients may be varied widely to suit the intent and/or other needs or requirements for a particular application or pizza product such as to enhance rise (leavening) and extensibility (e.g. workability of the dough component for the process/procedures).

According to any exemplary embodiment, improvers for the dough components that serve a functional role in the preparation or manufacture of a pizza product may be employed. Such improvers may comprise the additives and ingredients listed in TABLE 2.

Composition of an example dough component used in the pizza product may comprise any of a wide variety of ingredients and flour types (e.g., wheat flour, rice flour, etc.), along with sugar, yeast, salt, water, oil, etc. in suitable percentages, according to various exemplary embodiments selected and formulated to provide suitable characteristics for the pizza product.

As indicated, any ranges provided for ingredients of any dough component according to various exemplary embodiments are approximate; percentage ranges of ingredients could be varied (even widely) according to other exemplary and alternative embodiments. According to various exemplary embodiments, in the formulation of a dough component, bread flour could be replaced with and all-purpose flour or “00” durum flour or other functional flour for the system/method or product. For example, the flour for the dough component could be a blend with constituents/ingredients mixed in a range; for example, approximately 50 percent bread flour and approximately 50 percent all-purpose flour would provide a more tender consistency; small percentages (e.g. around 10 percent of the flour) could include whole wheat flour or other whole grain flours (e.g. quina, etc.), in formulations of the dough component that can be adapted according to cultural/popular tastes or other appeal. Such formulations may be developed for the system and method to give the final product distinct texture and flavors (or as part of a marketing strategy targeting certain customer desires, such as for a product that can be considered or perceived as healthier, etc.).

According to various exemplary embodiments, water could be provided in any of a range of percentages; for example, according to one exemplary embodiment, water may be in a range of between approximately 60 and 75 percent (as workable). Other formulations may alter combinations of water and improvers; for example, a wetter dough component (approximately 75 percent hydration) would be more workable if it included approximately 5 percent (vital) wheat gluten. flavorful liquid could be substituted for water (in some form); for example, a tomato-water stock or a mushroom stock may be used to flavor the dough component; other desired flavors may also be put into the dough component through ingredients or other ranges of other additives that are flavorful. According to an exemplary embodiment, tomato/mushroom powders (e.g. approximately 3-5 percent) could be added to the dough component; additions of dried powders (e.g. tomato, mushroom, etc.) would start to build flavors into the dough component before other ingredients are mixed into the dough component. According to various exemplary embodiments, salt could be in approximately a 1-2 percent range. Sugars or other sweeteners may be added to the dough component.

According to various exemplary embodiments, instant yeast concentrations could range up to approximately 1 percent (e.g. depending on how quickly one is trying to manufacture the product). According to an alternative embodiment, fresh yeast may be used (e.g. usually used at about three times the weight of instant yeast, and thus approximately 1-3 percent). Other leavening agents could be used in conjunction with the yeast; for example, encapsulated leavening agents (e.g. in concentrations of approximately 0.25-0.75 percent) may be provided to aid in rise during baking (e.g. will not activate until the dough component reaches a certain temperature).

According to other exemplary embodiments, the dough component for the dough base could be produced using any number of proprietary blends commercially available from suppliers (for example, including various combinations and blends of the ingredients in TABLE 2). According to another exemplary embodiment, the system and method could be implemented and/or adapted to produce non-gluten bread products; for example, gluten-free flours such as rice, oat, amaranth, potato, sorghum, and tapioca could be used in various formulations of a dough component. Gums such as xanthan or carrageenan could be provided as improvers/ingredients for the dough component according to exemplary embodiments. According to an exemplary embodiment, esters (in powder/granular form) may be added as an improver/ingredient to the dough component (e.g. to add fermentative flavor).

It is important to note that the construction and arrangement of the elements of the inventions as described in system and method and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

In the description, reference is made to the accompanying drawings, which form a part of the specification. In the drawings, similar symbols typically identify similar components, unless context dictates otherwise. The illustrative embodiments described in the description, drawings, and claims are not meant to be limiting. Other embodiments may be utilized, and other changes may be made, without departing from the spirit or scope of the subject matter presented in the application.

While various aspects and embodiments have been disclosed in the application, other aspects and embodiments will be apparent to those skilled in the art. The various aspects and embodiments disclosed in the application are for purposes of illustration and are not intended to be limiting, with the true scope and spirit being indicated by the claims as presented and/or amended.

### Tables

TABLE 1

| | PERCENT |
|---|---|
| INGREDIENT | (APPROX.) |
| Bread flour | 100.0 |
| Water | 70.0 |
| Instant yeast | 0.3 |
| Salt | 1.0-2.0 |

TABLE 2

| | | AMOUNT | INTENDED OR DESIRED |
|---|---|---|---|
| TYPE | ADDITIVE | (approximate unit percent) | EFFECT |
| Proteins | Gluten | 3-10% of flour (depends | Strengthens dough |
| | | on type of flour) | |
| | Bean flour (fava, | Fava 0-0.2% of flour | Strengthens flour |
| | soybean, etc.) | Soybean 0.2-0.3% of flour | |
| | Whey | to suit | Minor addition of protein; |
| | | | strengthens dough; sugars help |
| | | | browning |
| Enzymes | Transglutaminase | 1% (iterate) | Larger holes; increased volume up to |
| | | | certain concentration; reduces |
| | | | allergenicity of gluten |
| | Amylase (malt) | 1-10% of flour | Breaks down starch to sugars; |
| | | | increased caramelization |
| | Fungal α-amylase | to suit | Sugar for caramelization and feeding |
| | | | yeast; breaks down starch; |
| | | | degrades/softens gluten; useful for |
| | | | producing liquid doughs (crackers, |
| | | | flatbreads) |
| | Protease | to suit | Reduce mixing time (protease) |
| Yeast | Non-rising yeast | to suit | |
| | Inactive yeast | to suit | Add flavor |
| Gums | Guar gum | up to 1% | Tolerance to over mixing; increased |
| | | | water absorption; stronger dough |
| | | | (more resistant to mixing) |
| | Xanthan | 0.1-0.5% | Better crumb structure |
| | Carboxylmethyl | 0.1-0.5% | Increase bread volume |
| | cellulose | | |
| | Locust bean gum | to suit | Extend shelf-life |
| | Alginate | 0.1-0.5% | Anti-staling agent; affects crumb |
| | | | hardness, staling time; increases |
| | | | dough volume |
| | κ-Carrageenan | 0.1-0.5% | |
| Acids | Ascorbic acid | 20-80 mg/kg flour (max | Improves dough strength; increase |
| | (Vitamin C) | 300 mg/kg flour) | loaf volume (e.g. ~20%); decreases |
| | | | length of fermentation, with possibly |
| | | | less organic acid formation and less |
| | | | flavor; oxidation |
| | Lecithin | 0.1-1.0% of flour | Reduces dough stickiness |
| | L-Cysteine | 0.1% | Improves dough extensibility |
| | Citric acid | 0.5% of flour | Less sticky dough |
| Other | Oxygen | to suit | Bleaches dough |
| | Potassium bromate | to suit | Strengthens dough; increases dough |
| | | | volume |
| | Potassium iodate | to suit | Oxiding agent |
| | Azodiacarbonamide | to suit | Oxiding agent |
| | Datem | 0.375-0.5% | Strengthen gluten network |

1. An apparatus to produce a pizza product having a shell formed from a dough component comprising:
a base;
a fixture within the base for supporting the dough component formed into the shell;
a tool configured with a set of ports inserted into the dough component of the shell to form a set of cavities in the shell by a cavity-forming operation;
wherein the shell comprises an interior region and a perimeter region outside of the interior region.

2. The apparatus of claim 1 further comprising a forming tool to flatten the dough component into the shell.

3. The apparatus of claim 2 wherein the tool performing the cavity-forming operation is configured to form the set of cavities within the shell adjacent to the perimeter region of the shell.

4. The apparatus of claim 1 wherein the perimeter region comprises a perimeter edge.

5. The apparatus of claim 4 wherein the perimeter edge will form a crust of the pizza product and the central area provides a base for toppings of the pizza product.

6. (canceled)

7. (canceled)

8. The apparatus of claim 1 wherein the tool performing the cavity-forming operation is configured to form the set of cavities within the interior region of the shell.

9-13. (canceled)

14. The apparatus of claim 1 wherein the tool performs the cavity-forming operation in the fixture.

15. The apparatus of claim 1 wherein the cavity-forming operation comprises inserting a tool at least partially into the dough component of the shell.

16. The apparatus of claim 1 wherein the cavity-forming operation comprises supplying a fluid through the set of ports to form the set of cavities.

17. The apparatus of claim 1 wherein the cavity-forming operation comprises injecting a fluid through the set of ports to form the set of cavities.

18. The apparatus of claim 1 wherein the cavity-forming operation comprises supplying a fill material through a set of ports to fill the set of cavities.

19. The apparatus of claim 1 wherein the cavity-forming operation comprises supplying a fill material through the set of ports to establish the set of cavities.

20. The apparatus of claim 1 wherein the cavity-forming operation comprises supplying heat to set the cavities.

21. The apparatus of claim 18 wherein the cavity-forming operation comprises supplying heat to set the fill in the cavities.

22. The apparatus of claim 1 wherein the cavity-forming operation comprises enlarging the set of cavities.

23. The apparatus of claim 1 wherein the cavity-forming operation comprises enlarging the set of cavities by supplying a fill material.

24. The apparatus of claim 1 wherein the fixture comprises a shape having sidewalls and the cavity-forming operation comprises expanding the shell into the sidewalls of the fixture to conform the shell to the shape of the fixture.

25. The apparatus of claim 1 wherein the cavity-forming operation comprises a tool inserted in the dough component of the shell at each set of ports to initiate the formation of the set of cavities.

26. The apparatus of claim 1 wherein the cavity-forming operation comprises a forming operation using a tool to form the set of cavities and a maintaining operation to maintain the shape of the set of cavities.

27-35. (canceled)

36. The apparatus of claim 1 wherein the cavity-forming operation is continued during finishing of the pizza product.

37. The apparatus of claim 1 wherein the cavity-forming operation comprises applying heat within the set of cavities.

38-61. (canceled)

62. The apparatus of claim 1 wherein the fixture comprises sidewalls to form the edge of the shell.

63. The apparatus of claim 1 wherein the fixture comprises sidewalls to retain the edge of the shell.

64. The apparatus of claim 63 wherein the set of ports is configured to be inserted and retracted into the dough component within the fixture.

65. The apparatus of claim 62 wherein the set of ports is configured to be inserted and retracted into the dough component from sidewalls of the fixture.

66-101. (canceled)

102. A process for producing a pizza product comprising the steps of:
mixing a first set of ingredients into a dough component;
forming the first dough component into a shell;
forming a set of cavities in the shell with a cavity-forming operation;
finishing the pizza product.

103-106. (canceled)

107. The process of claim 102 wherein finishing the pizza product comprises baking the pizza product into a baked pizza product.

108. The process of claim 102 wherein finishing the pizza product comprises par-baking the pizza product.

109. The process of claim 102 wherein finishing the pizza product comprises freezing the pizza product.

110-113. (canceled)

114. The process of claim 102 wherein the cavity-forming operation is performed in a fixture that comprises a multi-port apparatus configured to form a multi-cavity pizza product having multiple cavities.

115. The process of claim 114 wherein the multi-port apparatus is inserted into the shell then retracted from the shell to form and establish multiple cavities.

116. The process of claim 114 wherein the multi-port apparatus is inserted into the shell then retracted from the shell then reinserted into the shell and retracted from the shell to form and establish and maintain multiple cavities.

117. The process of claim 114 wherein the multiple cavities are multiple-filled cavities filled with a fill material.

118-121. (canceled)

122. The process of claim 102 wherein forming the set of cavities comprises application of heat adjacent to each of the cavities.

123. The process of claim 122 wherein the application of heat comprises the use of a heated fluid.

124. The process of claim 122 wherein the application of heat comprises the use of a tool that is heated.

125-187. (canceled)

188. A system for producing a pizza product comprising:
a mixing station for mixing a first set of ingredients into a dough component;
a shape-forming station comprising an apparatus for forming the dough component into a generally flat pizza shell having a perimeter region and an interior region and a thickness;
a cavity-forming station comprising an apparatus with a set of outlets for forming a set of cavities in the shell in a cavity-forming operation; and
a finishing station for finishing the pizza shell into the finished pizza product.

189-192. (canceled)

193. The system of claim 188 wherein the fixture comprises a tool having a set of ports corresponding to the set of outlets to form the set of cavities in the shell.

194. The system of claim 193 wherein the set of ports is used to fill the set of cavities into a set of filled cavities each containing a fill material.

195. The system of claim 193 wherein the set of ports is used to fill the set of cavities into open cavities.

196. The system of claim 188 wherein the cavity-forming operation uses a set of ports providing the outlets and configured to inject a fluid into the dough shell.

197. The system of claim 189 wherein the forming station comprises a flattening tool.

198-273. (canceled)

274. A pizza product comprising: a shell formed from a dough component; wherein the shell has an interior region and a perimeter region outside of the interior region; wherein a set of cavities is formed within the dough component of the shell adjacent an edge of the perimeter region of the shell by a cavity-forming operation; wherein toppings may be applied to the interior region of the shell; wherein the perimeter edge of the shell around the toppings is configured to form a crust when the pizza product is baked; so that the finished pizza product from the shell comprises a set of cavities in the crust.

275-278. (canceled)

279. The product of claim 274 wherein the set of cavities is formed in the interior region.

280. The product of claim 274 wherein the set of cavities is absent from the interior region.

281. The product of claim 274 wherein the set of cavities comprises a pattern of filled cavities.

282-327. (canceled)

328. A pizza product comprising: a shell formed from a dough component; wherein the shell has an interior region with a set of generally depressed areas and generally raised ridges within a perimeter region providing a raised edge around the interior region relative to the depressed areas; wherein a set of cavities is formed within the raised ridges and raised edge of the shell by a cavity-forming operation; wherein the raised ridges and raised edge of the shell with the depressed areas in the interior of the shell define locations for toppings to be applied; and wherein the raised ridges and raised edge of the shell when baked provide a crust-like effect so that the finished pizza product will comprise a set of identifiable individual segments of a filled-crust pizza product.

329. (canceled)

330. (canceled)

331. The product of claim 328 wherein the set of cavities is formed by a fluid.

332. The product of claim 331 wherein the fluid comprises a fill material.

333. The product of claim 332 wherein the fill material comprises at least one of cheese, pizza sauce, vegetable-derived matter, dairy-based matter, segments of pizza toppings.

334-363. (canceled)
